(19) United States
(12) Patent Application Publication
(10) Pub. No.: US 2023/0290115 A1
(43) Pub. Date: Sep. 14, 2023

(54) METHOD, APPARATUS AND NON-TRANSITORY COMPUTER READABLE MEDIUM

(71) Applicant: NEC Corporation, Minato-ku, Tokyo (JP)

(72) Inventors: Hui Lam ONG, Singapore (SG); Pujianto Christopher CHIAM, Singapore (SG); Satoshi YAMAZAKI, Singapore (SG)

(73) Assignee: NEC Corporation, Minato-ku, Tokyo (JP)

(21) Appl. No.: 18/015,468

(22) PCT Filed: Jul. 8, 2021
(86) PCT No.: PCT/JP2021/025844

§ 371 Date: Jan. 10, 2023

(30) Foreign Application Priority Data
Jul. 17, 2020 (SG) 10202006872

(51) Int. Cl. G06V 10/762; G06V 20/40; G06V 20/52; G06V 10/75

(52) U.S. Cl. CPC G06V 10/763; G06V 20/41; G06V 20/53; G06V 10/75

(57) ABSTRACT

A method, an apparatus and a non-transitory computer readable medium may be provided. In one aspect, a method performed by a computer includes: matching an input image against at least one of images corresponding to a network of subjects to identify a subject corresponding to the input image, the input image comprising at least one label corresponding to the identified subject; and determining whether or not to eliminate a node representing the subject in the network of subjects based on the at least one corresponding label.

### TECHNICAL FIELD

The present disclosure relates to a method, an apparatus and a non-transitory computer readable medium.

### BACKGROUND ART

Contact tracing is becoming one of the common approaches used in many countries during pandemic outbreak, to control and contain the disease within a small infected group.

Contact tracing with video analytics system helps to cut down the need of human effort to manually go through video footages. Advantageously, this can not only speed up the process of identifying all the connected persons, but also minimize human errors. The result of contact tracing can be then presented in network diagram format through graphical user interface for future investigation.

### SUMMARY OF THE INVENTION

### Technical Problem

Contact tracing network diagram for any sizable public events is usually equipped with tens of hundreds of cameras. The network diagram of connected persons from all these video footages can be overwhelming and time consuming for any human investigators to perform data analysis, as there will be hundreds or thousands of connected persons. Prioritization will be the key challenge in order to perform effective investigation for timely decision making.

Especially during a pandemic like COVID-19 (Coronavirus disease 2019), the number of infected persons can grow exponentially each day. It is possible to generate a large network of persons who potentially spread the disease from one subject to another. It would be challenging to manually plough through the data to detect the transmission link of the disease (where two seemingly unconnected subjects are infected); and uncover persons in contact with an infected subject with the highest risk of contracting the disease from the subject.

An object of the present disclosure is to provide a method, an apparatus and a non-transitory computer readable medium capable of adaptively managing images corresponding to a network of subjects.

Furthermore, other desirable features and characteristics will become apparent from the subsequent detailed description and the appended claims, taken in conjunction with the accompanying drawings and this background of the disclosure.

### Solution to Problem

In a first example aspect, a method comprises: matching an input image against at least one of images corresponding to a network of subjects to identify a subject corresponding to the input image, the input image comprising at least one label corresponding to the identified subject; and determining whether or not to eliminate a node representing the subject in the network of subjects based on the at least one corresponding label.

In a second example aspect, an apparatus comprises: a memory in communication with a processor, the memory storing a computer program recorded therein, the computer program being executable by the processor to cause the apparatus at least to: match an input image against at least one of images corresponding to a network of subjects to identify a subject corresponding to the input image, the input image comprising a label corresponding to the identified subject; and determine whether or not to eliminate a node representing the subject in the network of subjects based on the corresponding label.

In a third example aspect, a system comprises: the apparatus according to the second example aspect and at least one image capturing device.

In a fourth example aspect, a non-transitory computer readable medium storing a program for causing a computer to execute: matching an input image against at least one of images corresponding to a network of subjects to identify a subject corresponding to the input image, the input image comprising at least one label corresponding to the identified subject; and determining whether or not to eliminate a node representing the subject in the network of subjects based on the at least one corresponding label.

### Advantageous Effects of Invention

According to the present disclosure, it is possible to provide a method and an apparatus and a non-transitory computer readable medium capable of adaptively managing images corresponding to a network of subjects.

### BRIEF DESCRIPTION OF DRAWINGS

The accompanying Figures serve to illustrate various embodiments and to explain various principles and advantages in accordance with a present embodiment, by way of non-limiting example only. Also, reference numerals in the accompanying Figures and the whole of this document refer to identical or functionally similar elements throughout the separate views and the detailed description below, which is incorporated in and forms part of the specification.

Embodiments of the disclosure will be better understood and readily apparent to one of ordinary skill in the art from the following written description, by way of example only, and in conjunction with the drawings, in which:

FIG. 1 shows a system for adaptively displaying at least one potential subject and a target subject according to an aspect of the present disclosure.

FIG. 2 shows a graphical representation of adaptively displaying a network of subjects according to an embodiment of the present disclosure.

FIG. 3A shows a flow chart illustrating a process of identifying a network of subjects according to an embodiment of the present disclosure.

FIG. 3B shows a flow chart illustrating a process of adaptively managing image corresponding to a network of subjects according to an embodiment of the present disclosure.

FIG. 4A shows example processes of determining whether or not to eliminate a node representing a subject in a network of subjects.

FIG. 4B shows example processes of determining whether or not to eliminate a node representing a subject in a network of subjects.

FIG. 4C shows example processes of determining whether or not to eliminate a node representing a subject in a network of subjects.

FIG. 5A shows other example processes of determining whether or not to eliminate a node representing a subject in a network of subjects.

FIG. 5B shows other example processes of determining whether or not to eliminate a node representing a subject in a network of subjects.

FIG. 5C shows other example processes of determining whether or not to eliminate a node representing a subject in a network of subjects.

FIG. 6A shows yet other example processes of determining whether or not to eliminate a node represent a subject in a network of subjects.

FIG. 6B shows yet other example processes of determining whether or not to eliminate a node represent a subject in a network of subjects.

FIG. 7A shows example processes of calculating a group score of each group of subjects in a network of subjects.

FIG. 7B shows example processes of calculating a group score of each group of subjects in a network of subjects.

FIG. 8 shows a flow diagram illustrating a method of adaptively managing image corresponding to a network of subjects according to an embodiment of the present disclosure.

FIG. 9 shows an exemplary computing device that may be used to execute the method of the earlier figures.

FIG. 10 shows an apparatus according to another aspect of the present disclosure.

FIG. 11 shows a flow chart illustrating a process of a method according to the another aspect of the present disclosure.

### DESCRIPTION OF EMBODIMENTS

(Definition of Terms)

Prior to explaining embodiments according to this present disclosure, the following explanatory notes regarding definition of terms will be given.

Subject: a subject may be any suitable type of entity, which may include a person, a patient and a user. For the purposes of the description below, a subject may refer to both a target user and a potential subject and the identity of a subject as a target subject may change to a potential subject. A subject may be represented by a node in a network of subjects.

The term of “target subject” is used herein to identify a person, a user or patient that is of interest. The target subject may be one that is selected by a user input or one who is identified to be a carrier of an infectious disease or a certain strand of the infectious disease. The target subject may also be one shown in an input image.

A potential subject is used herein to relate to a person who is related to the subject (e.g., partner or companion) or in-contact with the target subject. In various embodiments below, a potential subject may refer to a subject that has a direct or indirect co-appearance with the target subject. Specifically, under direct co-appearance, a potential subject may co-appear with a target subject at a same time and location (or in a same image) or within a same time period at a same location; whereas under indirect co-appearance, a target subject and a potential subject may appear at a same location but in two proximate time periods respectively, for example the potential subject may appear at the location at a time close to the time at which, or within an extended time period before or after the time period in which, the target subject appears. For example, in the context of pandemic outbreak, the potential subject is someone who may be at a risk of contracting disease or spreading the one from the potential subject to others.

A network of subjects (or a network diagram) is used herein to relate to a graphical representation of a cluster of subjects (target subjects and potential targets) connecting to each other, each node representing a subject within the cluster of subjects, and each two connected nodes representing two subjects within the cluster of subjects who may have appeared at a same location during a different time period or at a same timing. In various embodiments, each node in a network of subjects has a node identifier (ID) used for identifying a subject in the network of subject, and is associated with name and ID card number of the subject, and image(s) such as facial portrait or appearances of the subject for further subject and node identification.

A group of subjects is used herein to relate to a subset of the network of subjects. In various embodiments below, when one or more node is eliminated in the network of subjects, two groups of subjects may form within the network of subjects (group splitting), where none of the subjects in one group of subjects is connected to any subject in another group of subjects within the network of subjects.

A connection strength is used herein to represent a relationship, or how closely related or connected, between two subjects corresponding to two connected nodes. In various embodiments below, a connection strength between two subjects may be higher when the two subjects are more often detected to directly or indirectly co-appear at a same location and/or in contact with each other. In various embodiments, the term “connection strength” and the term “co-appearance strength” may be used interchangeably.

A group score is used herein to relate to an overall connection strength among all subjects within a group of subjects. A group score may be calculated by taking into account of every two connected nodes within a group of subjects and their corresponding connection strength. Additionally or alternatively, a group score may be calculated based on a number of subjects (nodes) within a group of subjects. In various embodiments below, a group score of a group of subjects may be higher when there are more subjects within the group of subjects and the connection strengths among the subjects within the group of subjects are greater.

A label is used herein to provide additional information on an event relating a subject and function to further categorize the subject with respect to other subject(s) in the network of subjects. Such label or additional information of a subject may be received along with an image input used for identifying the subject in the network of subjects. Examples of a label may include a location, a time, a measurement outcome associated with the subject. In various embodiments below, based on a label corresponding to a subject, the following step may be carried out on a node in a network of subjects representing the subject: (i) elimination of the node from the network of subjects, and as a result, two or more subjects may form within the network of subjects (group splitting); (ii) amplification of each connection strength between two subjects in relation to the subject, i.e. where one of two connected nodes is the node representing the subject, and as a result, amplification of a group score of a group of subjects comprising the subject.

A user who is registered to a contact tracing server will be called a registered user. A user who is not registered to the contact tracing server will be called a non-registered user. It is possible for the user to obtain graphical representation of any subject on a network diagram.

Contact tracing server: the contact tracing server is a server that hosts software application programs for receiving inputs, processing data and objectively providing graphical representation. The contact tracing server communicates with any other servers (e.g., a remote assistance server) to manage requests. The contact tracing server communicates with a remote assistance server to display a graphical representation of a potential subject and a target subject. Contact tracing servers may use a variety of different protocols and procedures in order to manage the data and provide a graphical representation.

The contact tracing server is usually managed by a provider that may be an entity (e.g., a company or organization) which operates to process requests, manage data and display graphical representations that are useful to a situation. The server may include one or more computing devices that are used for processing graphical representation requests and providing customizable services depending on situations.

A contact tracing account: a contact tracing account is an account of a user who is registered at a contact tracing server. In certain circumstances, the contact tracing account is not required to use the remote assistance server. A contact tracing account includes details (e.g., name, address, vehicle etc.) of a user.

The contact tracing server manages contact tracing accounts of users and the interactions between users and other external servers, along with the data that is exchanged.

(Other Notes)

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to related art arrangements relate to discussions of devices which form public knowledge through their use. Also, such discussions should not be interpreted as a representation by the present inventor(s) or the patent applicant that such devices in any way form part of the common general knowledge in the art.

(First Example Embodiment)

A first example embodiment of the disclosure is explained below referring to the accompanying drawings. The following detailed description is merely exemplary in nature and is not intended to limit this disclosure or the application and uses of this disclosure. Furthermore, there is no intention to be bound by any theory presented in the preceding background of this disclosure or the following

### DETAILED DESCRIPTION

(System 100)

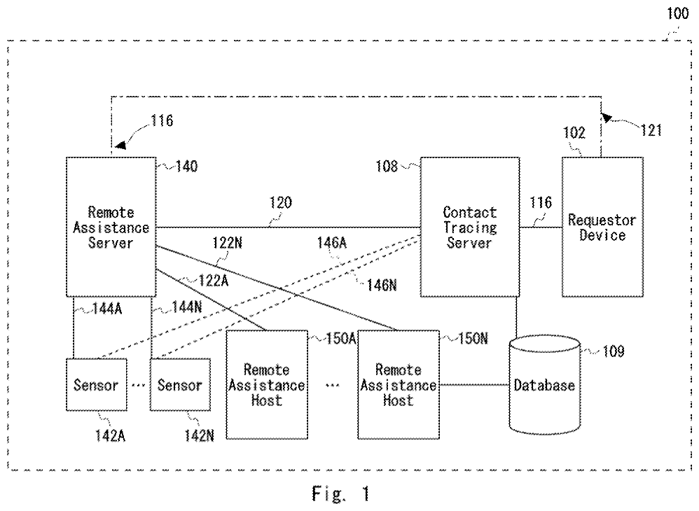

FIG. 1 illustrates a block diagram of a system 100 for adaptively managing images corresponding to a network of subjects.

The system 100 comprises a requestor device 102, a contact tracing server 108, a remote assistance server 140, remote assistance hosts 150A to 150N, sensors 142A to 142N and a database 109. However, the system 100 may have another computer or device if necessary.

The requestor device 102 is in communication with a contact tracing server 108 and/or a remote assistance server 140 via a connection 116 and 121, respectively. The connection 116 and 121 may be wireless (e.g., via NFC (Near field communication), Bluetooth ((R): Registered trademark), etc.). The connection 116 and 121 may over a network (e.g., the Internet).

The contact tracing server 108 is further in communication with the remote assistance server 140 via a connection 120. The connection 120 may be over a network (e.g., a local area network, a wide area network, the Internet, etc.). In one arrangement, the contact tracing server 108 and the remote assistance server 140 are combined and the connection 120 may be an interconnected bus.

The remote assistance server 140, in turn, is in communication with the remote assistance hosts 150A to 150N via respective connections 122A to 122N. The connections 122A to 122N may be a network (e.g., the Internet).

The remote assistance hosts 150A to 150N are servers. The term host is used herein to differentiate between the remote assistance hosts 150A to 150N and the remote assistance server 140. The remote assistance hosts 150A to 150N are collectively referred to herein as the remote assistance hosts 150, while the remote assistance host 150 refers to one of the remote assistance hosts 150. The remote assistance hosts 150 may be combined with the remote assistance server 140.

In an example, the remote assistance host 150 may be one managed by a hospital and the remote assistance server 140 is a central server that manages emergency calls and decides which of the remote assistance hosts 150 to forward data or retrieve data like image inputs. For example, in the context of pandemic outbreak, a hospital may identify a subject in a network diagram who may be at a risk of contracting an infectious disease or a certain strand of the infectious disease or spreading it from the potential subject to others. Emergency calls may be done to contact the subject or any relevant authority.

The sensors 142A to 142N are connected to the remote assistance server 140 or the contact tracing server 108 via respective connections 144A to 144N or 146A to 146N. The sensors 142A to 142N are collectively referred to herein as the sensors 142. The connections 144A to 144N are collectively referred to herein as the connections 144, while the connection 144 refers to one of the connections 144. Similarly, the connections 146A to 146N are collectively referred to herein as the connections 146, while the connection 146 refers to one of the connections 146. The connections 144 and 146 may be wireless (e.g., via NFC communication, Bluetooth, etc.) or over a network (e.g., the Internet). The sensor 142 may be one of an image capturing device, video capturing device, motion sensor and temperature sensor, and may be configured to send an input depending its type, to at least one of the contact tracing server 108.

In the illustrative embodiment, each of the devices 102 and 142; and the servers 108, 140, and 150 provides an interface to enable communication with other connected devices 102 and 142 and/or servers 108, 140, and 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof.

Use of the term ‘server’ herein can mean a single computing device or a plurality of interconnected computing devices which operate together to perform a particular function. That is, the server may be contained within a single hardware unit or be distributed among several or many different hardware units.

(Remote assistance server 140)

The remote assistance server 140 is associated with an entity (e.g., a company or organization or moderator of the service). In one arrangement, the remote assistance server 140 is owned and operated by the entity operating the server 108. In such an arrangement, the remote assistance server 140 may be implemented as a part (e.g., a computer program module, a computing device, etc.) of the server 108.

The remote assistance server 140 may also be configured to manage the registration of users. A registered user has a contact tracing account (see the discussion above) which includes details of the user. The registration step is called on-boarding. A user may use the requestor device 102 to perform on- boarding to the remote assistance server 140.

It is not necessary to have a contact tracing account at the remote assistance server 140 to access the functionalities of the remote assistance server 140. However, there are functions that are available to a registered user. For example, it may be possible to display graphical representation of target subjects and potential subjects in other jurisdictions. These additional functions will be discussed below.

The on-boarding process for a user is performed by the user through the requestor device 102. In one arrangement, the user downloads an app (which includes the API to interact with the remote assistance server 140) to the sensor 142. In another arrangement, the user accesses a website (which includes the API to interact with the remote assistance server 140) on the requestor device 102.

Details of the registration include, for example, user identifier (ID) or facial portrait of the user, address of the user, emergency contact, or other important information and the sensor 142 that is authorized to update the remote assistance account, and the like.

Once on-boarded, the user would have a contact tracing account that stores all the details.

(Requestor device 102)

The requestor device 102 is associated with a subject (or requestor) who is a party to a contact tracing request that starts at the requestor device 102. The requestor may be a concerned member of the public who is assisting to get data necessary to obtain a graphical representation of a network diagram. The requestor device 102 may be a computing device such as a desktop computer, an interactive voice response (IVR) system, a smartphone, a laptop computer, a personal digital assistant computer (PDA), a mobile computer, a tablet computer, and the like.

In one example arrangement, the requestor device 102 is a computing device in a watch or similar wearable and is fitted with a wireless communications interface.

(Contact tracing server 108)

The contract tracing server 108 is as described above in the terms of description section. The contact tracing server 108 is configured to process processes relating to objectively manage a network diagram and adaptively display a potential subject and a target subject.

(Remote assistance hosts 150)

The remote assistance host 150 is a server associated with an entity (e.g., a company or organization) which manages (e.g., establishes, administers) healthcare information regarding information relating to a subject who is likely to be at risk of a disease.

In one arrangement, the entity is a hospital and each entity operates a remote assistance host 150 to manage the resources by that entity. In one arrangement, a remote assistance host 150 receives an alert signal that a subject is likely to be carrier of an infectious disease. The remote assistance host 150 may then arrange to send resources to the location identified by the location information included in the alert signal. For example, the host may be one that is configured to obtain relevant video or image input for processing.

In one arrangement, the images corresponding to a network of subjects may be adaptively managed and automatically updated on the contact tracing account associated with the user. Advantageously, such information is valuable to the law enforcement and the user such as medical or building management staff who does contact tracing. It reduces number of hours looking through camera footage to investigate the possible links between persons of interest.

The information is particularly useful in the pandemic, so that building management and the health sector can more efficiently and effectively carry out contact tracing. The network of co-appearances, coupled with duration and distance analyzer, helps to identify how the disease spreads from one person to another.

Conventionally, contact tracing is extremely labor intensive. Many officers who are tasked to analyze hours of video and image footage might be prone to fatigue and errors. That leads to misdetection of the potential person with illness symptoms.

(Sensor 142)

The sensor 142 is associated with a user associated with the requestor device 102. More details of how the sensor may be utilized will be provided below.

(Graphical representation)

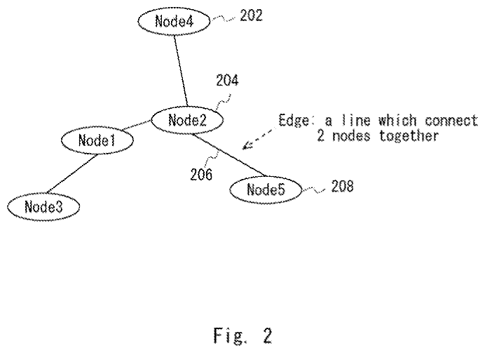

FIG. 2 shows a graphical representation of adaptively managing images corresponding to a network of subjects according to an embodiment of the present disclosure.

Each node 202, 204 and 208 represents a subject. Each edge 206, which is a line or link, is one connects the two neighboring nodes and represents the relationship between the two neighboring nodes. Such neighboring nodes connected with an edge are hereinafter referred to as connected nodes. The relationship between two connected nodes may be one that is identified in determination of connection strength between two subjects.

(Process of identifying a network of subjects)

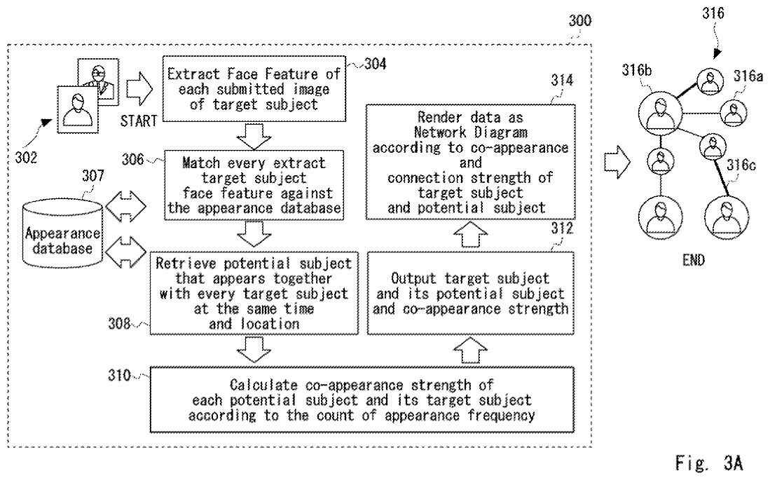

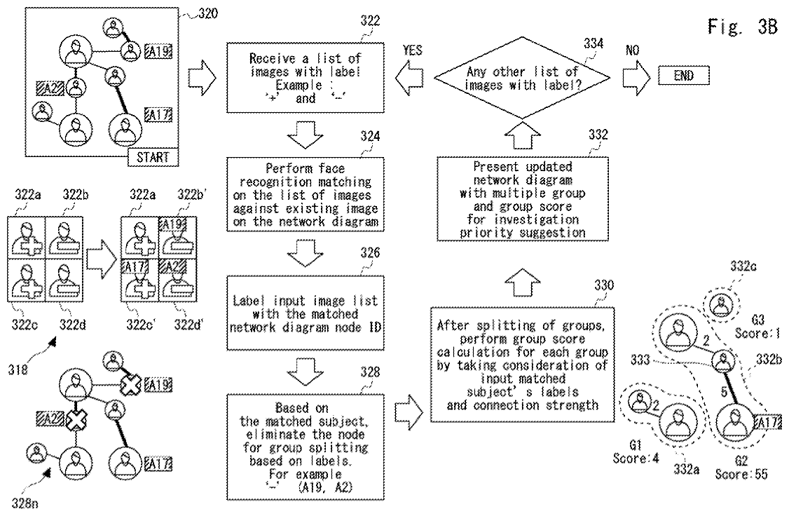

FIG. 3a shows a flow chart 300 illustrating a process of identifying a network of subjects according to an embodiment of the present disclosure. A plurality of images may be retrieved from an image input 302 received from at least one image capturing device and/or at least one storage device.

In step 304, appearance(s) (e.g., face feature) of a subject, e.g., target subject in this case, may be identified and extracted from each of the plurality of images of the image input. In an embodiment, an appearance database may comprise images of appearances corresponding to a list of subjects, e.g., known subjects or previously identified subjects. The appearance database may be the database 109.

In step 306, every target subject's appearance(s) identified from the image input 302 is matched against appearances in the appearance database 307. If a target subject's appearance identified from the image input 302 matches an appearance of one subject of the list of subjects in the appearance database 307, it is then determined that the target subject identified from the image input 302 corresponds to the one subject of the list of subjects in the appearance database 307; otherwise the target subject may be identified as a new subject and registered to the list of subjects for further identification and recognition of the new subject. In an embodiment, the appearance from the image input is stored in appearance database 307.

In step 308, potential subject(s), e.g., subject(s) that has a direct or indirect co-appearance with the target subject according to the image input 302 or the appearance database 307, is retrieved for every target subject identified from the image input. In other words, the potential subject appears together with every target subject at the same time and location.

In step 310, a connection strength, e.g., co-appearance strength, of each potential subject and its target subject is calculated according to a count of co-appearance(s), e.g., a count of appearance frequency. In an embodiment, a count of co-appearances is calculated by calculating a count of direct and/or indirect co-appearances of a potential subject and target subject pair based on the appearance database 307 and/or image input 302.

In step 312, a connection strength, e.g., co-appearance strength, between each pair of target subject and potential subject is output. The information of the target subject and its potential subject is also output.

In step 314, data of co-appearances and connection strengths of all pairs of target subjects and potential subjects are used to generate a network diagram, and as a result, a network of subjects 316 is identified based on such data. In one embodiment, images of appearance corresponding to each subject in the network of subjects may be used to represent the network of subjects 316 in a similar manner as that in FIG. 2. In an embodiment, in the network of subjects 316 in FIG. 3A, a node such as 316a, 316b which may comprise an image(s) of appearance, is used to represent a subject. An edge, a line or a link such as 316c connects two neighboring nodes and represents the relationship between the two neighboring nodes. For example, two neighboring nodes representing a target subject and a potential subject who are identified to both appear in a same image (a direct co-appearance) is linked by an edge such as 316c they are related to each other. In various embodiments, each edge between two connected nodes is associated with a connection strength between the two corresponding subjects (e.g., target subjects, potential subjects) depending on how closely related they are or how often they both directly or indirectly co-appear at a same location or in contact with each other. In various embodiments, each node in the network diagram representing a node in the network of subjects, is assigned with a network diagram node ID for further subject correspondence and identification. According to various embodiments, the term “network of subjects” and “network diagram” may be used interchangeably.

According to the present disclosure, images corresponding to a network of subjects may be adaptively managed, for example, to underline certain subject information of the network of subject.

FIG. 3B shows a flow chart illustrating a process of adaptively managing images corresponding to a network of subjects according to an embodiment of the present disclosure. In step 320, a network of subjects such as 316 in FIG. 3A together with images corresponding to the network of subject (e.g., existing images on the network diagram) is used as a base input.

Further, in step 322, input images (e.g. a list of images) 322a-322d may be received from at least one image capturing device and/or at least one storage device, where each input image comprises an appearance to be used for subject identification and at least one corresponding label, e.g. “+” and “−” to provide information for further categorization of the identified subject.

In step 324, a step of matching each input image 322a-322d is carried out against images corresponding to the network of subjects 320 to identify a subject in the network of subject 320. In an embodiment, this step is carried out by comparing an appearance identified from each input image 322a-322d against each appearance in the images corresponding to the network of subjects 320.

In step 326, if an appearance of a subject of an input image 322a-322d matches an appearance of one subject in at least one image of the images corresponding to the network of subjects 320, the subject of the input image is determined or may be labeled as the corresponding one subject in the network of subjects 320 based on the match result. Correspondingly, the information associated with label of the input image will be referred to the matched subject in the network of subjects 320 identified from the matching step 324.

For example, in FIG. 3B, the appearances of the subjects identified from the input images 322b, 322c, 322d match the appearances of the subjects of network diagram node ID of A19, A17, A2 in the network of subjects 320, as indicated in 322b′, 322c′, 322d′, respectively. Correspondingly, the information of “−”, “+”, “+” of the label of the input images 322b′, 322c′, 322d′ are referred to the subjects of network diagram node ID of A19, A17, A2 in the network of subject 320. In this way, the input image list us Labeled with the matched network diagram node ID.

In step 328, a step of determining whether or not to eliminate a node representing the subject in the network of subject based on the corresponding label is carried out. In an embodiment, based on the matched subjects in the network of subjects and the labels of input images, the node representing the matched subjects may be eliminated from the network of subjects.

In this example, nodes with node IDs A19, A2 representing matched subjects with a “−” label as shown in 322b′, 322d′ are determined to be eliminated, as depicted in 328n. According to the present disclosure, in response to elimination of node(s), some nodes or a group of nodes in the network of subject may become disconnected and do not with connect with certain any nodes from a group of nodes in the network diagram. This can lead to group splitting, where the network of subjects is divided, and two or more groups of subjects are generated from the network of subjects. In this example, three groups of subjects G1-G3 or 332a-332c are generated in response to elimination of nodes A19 and A2, where none of the subjects in each of group of subjects is connected with any subject of the remaining group of subjects.

In step 330, when two or more groups are generated in response to elimination of node(s), i.e., after splitting of groups, a step of calculating a group score of each group of subjects may be carried out. In an embodiment, the calculation of group score of a group of subjects is based on parameter relating to the group of subjects such as a number of subjects in the group of subjects (input matched subject's labels) and/or connection strengths among all subjects in the group of subjects.

In an embodiment, a group score is calculated based on a number of subjects in a group of subjects. For example, the third group of subjects G3, 332c has only 1 subject and therefore has a group score of 1.

In various embodiments, a connection strength represents how often two subjects both directly or indirectly co-appear at a same location or are in contact with each other. For example, based on the images of appearance database 307 and input 302 used for constructing the network of subjects 316 or in this case 320, it may be determined that the subject corresponding to node ID A17 may have appears with other subject of its neighboring node 333 in 5 images, hence the edge between the node ID A17 and its neighboring node 333 is associated with a connection strength of 5.

In another embodiment, a group score is calculated based on a combination of both number of subjects and the connection strengths among all subjects in the group of subjects. For example, the first group of subjects G1, 332a has a number of subjects of 2 and the connection strength between the two nodes are 2, and therefore has a group of 4 (2+2).

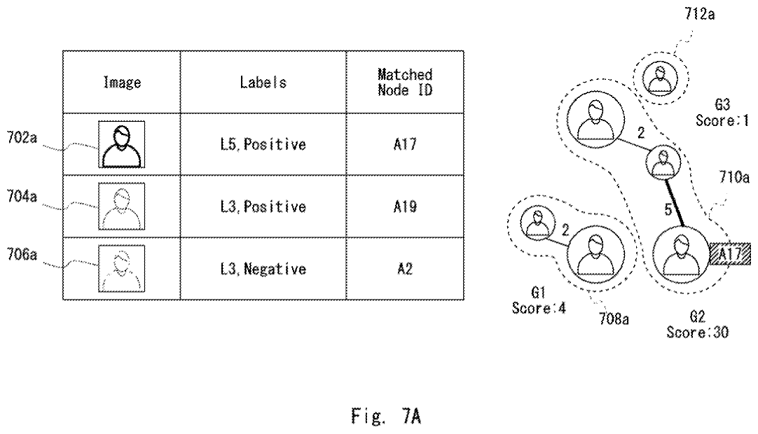

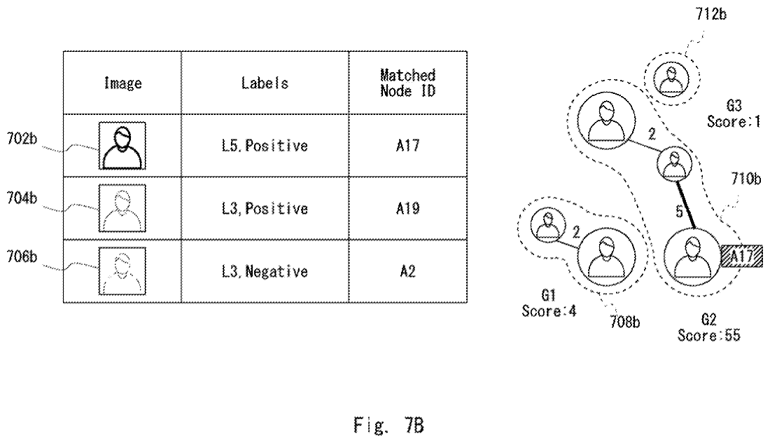

Yet in another embodiment, the calculation of group score may take into consideration of the corresponding label of the matched subject. The connection strength between two connected nodes with a “+” label may be multiplied, in this case the “+” label means a multiplication by 10. For example, when calculating a group score for the second group of subjects G2, 332b, the connection strength (5) between two connected nodes relating to node ID A17 representing matched subject with a “+” label as shown in 322c′ is multiplied, by 10 to become 50 (5×10). Therefore, the second group of subjects G2, 332b with 3 subjects may have a group score of 55 (3+2+50). More details on the group score calculation will be further elaborated in the following, in FIGS. 7A and 7B.

In step 332, an updated network diagram may be presented with multiple groups of subjects and their respective group scores. In an embodiment, the updated network diagram and the group scores may suggest investigation priority to be given to groups of subjects according to group scores. Advantageously, the user can easily narrow down the scope of the investigation to focus their resources on investigating those subjects within groups of subjects with high group scores, e.g., G2.

In step 334, it is then determined if there is any other list of images with label. If so, the process returns to step 332 which is carried out using the other list of images with label as input images. In an embodiment, a group of subjects in the network of subjects, e.g., G1, G2 or G3 generated in the step 330, may be subjected to further group splitting based on other list of images with label, and hence more groups of subjects are adaptively and dynamically formed based on the further input images. If there is no other list of images with label, the process of adaptively managing images corresponding to the network of subjects 320 may end.

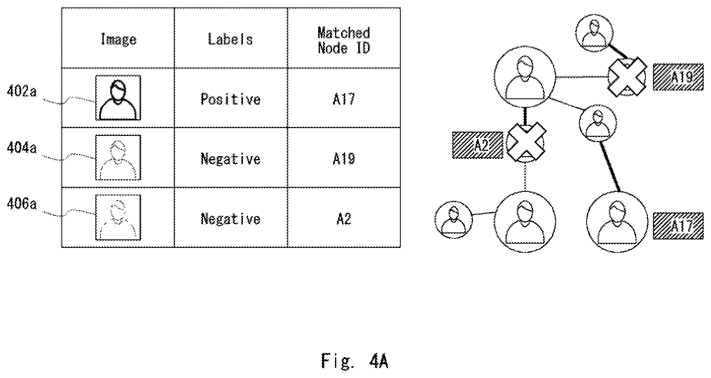

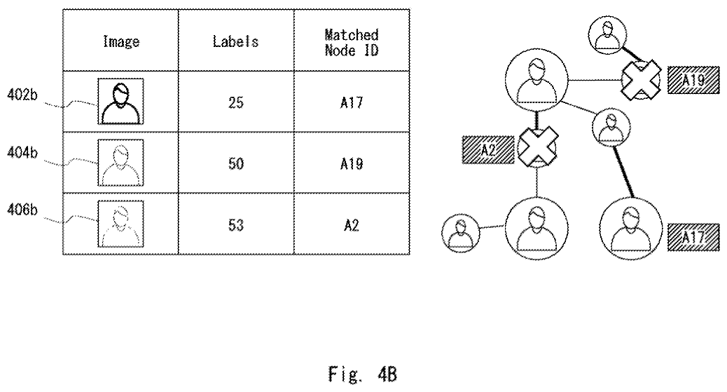

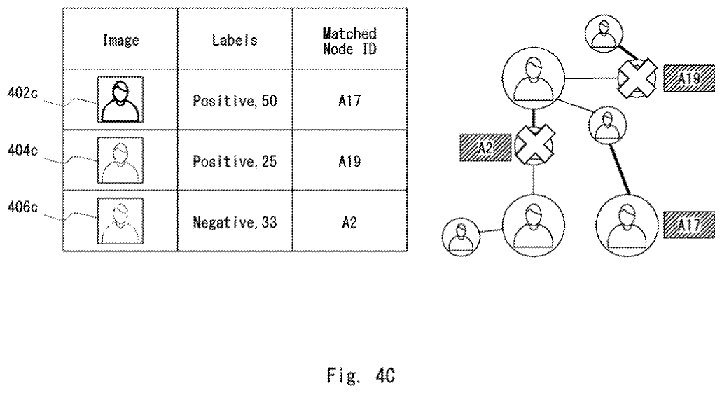

According to various embodiments of the present disclosure, a label of an image input provides additional information for further categorizing a subject in a network of subjects, and a matching label is a label that matches a desired condition. A node matching an input image is to be eliminated if the input image comprises one or more matching label. There are three types of label conditions for determining a node is to be eliminated and group splitting: (a) Type 1 where the determination for node elimination is based on one type of label matching a desired condition; (b) Type 2 where the determination for node elimination is based on two types of label matching respective desired conditions; (c) a combination of Type 1 and Type 2, where the determination for node elimination is based on one type of label matching the condition for certain type of label, and two types of label matching the respective conditions for certain other type of label. Details will be elaborated as follows, in FIGS. 4A-6B.

FIGS. 4A-4C show example processes of determining whether or not to eliminate a node representing a subject in a network of subjects based on one type of label matching a condition.

FIG. 4A shows an example process of determining whether or not to eliminate a node representing a subject in a network of subjects based on a corresponding label matching a desirable measurement outcome. In this example, the desirable measurement outcome is “negative”. In the context of a pandemic outbreak, this may refer to a subject who has been tested negative on a viral infection. In this example, it is determined that input images 404a and 406a comprise a label relating to “negative” measurement outcome and a match with the subjects in node IDs A19 and A2 in the network diagram respectively. As a result, with one matching corresponding label, the nodes with node IDs A19 and A2 are eliminated from the network diagram.

FIG. 4B shows another example process of determining whether or not to eliminate a node representing a subject in a network of subjects based on a corresponding label matching a numeral value which is larger than or equal to a threshold number. In this example, the threshold number is 50. In this example, it is determined that input images 404b and 406b comprise labels with numerical value larger than or equal to the threshold number of 50 and a match with the subjects in node IDs A19 and A2 in the network diagram respectively. As a result, with one matching corresponding label, the nodes with node IDs A19 and A2 are eliminated from the network diagram.

FIG. 4C shows yet another example process of determining whether or not to eliminate a node representing a subject in a network of subjects based on at least one of two corresponding labels matching a desirable measurement outcome or a target numerical value respectively. In an embodiment, a node is to be eliminated if a first corresponding label matches a desirable measurement outcome, and in this example, the desirable measurement outcome is “negative”; or if a second corresponding label has a numerical value smaller than a threshold number, and in this example, the threshold number is 50.

In this example, it is determined that both input images 404c and 406c comprise at least one matching corresponding label, specifically input image 404c comprises the second corresponding label having a numerical value smaller than the threshold number of 50 and a match with the subjects in node IDs A19 of the network diagram, while it is determined that input image 406c has its first corresponding label matching the “negative” measurement outcome and a match with the subjects in node IDs A2 in the network diagram. As a result, with at least one matching corresponding label, the nodes with node IDs A19 and A2 are eliminated from the network diagram.

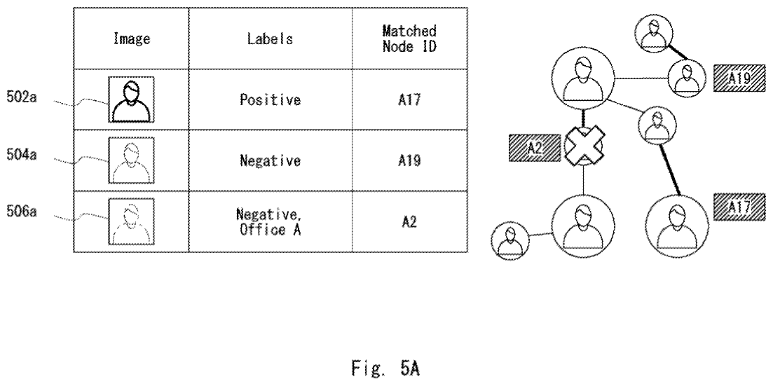

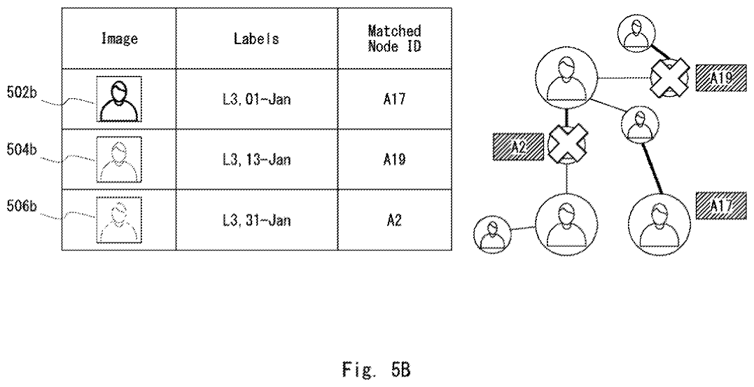

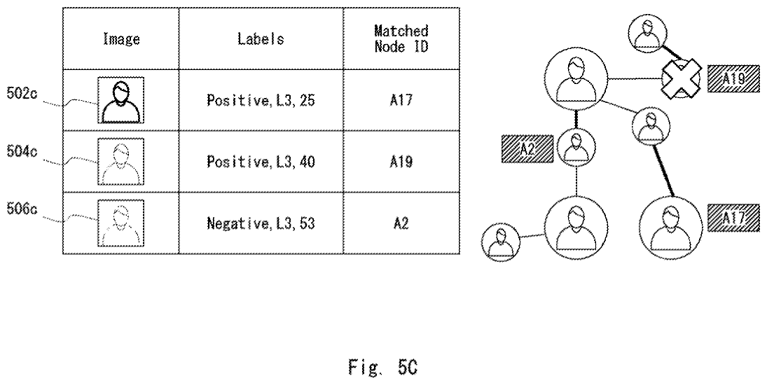

FIGS. 5A-5C show example processes of determining whether or not to eliminate a node representing a subject in a network of subjects based on two types of label matching respective conditions.

FIG. 5A shows an example process of determining whether or not to eliminate a node representing a subject in a network of subjects based on two corresponding labels matching a desirable measurement outcome and a target location respectively. In an embodiment, a node is to be eliminated if a first corresponding label relating to a measurement outcome matches a desirable measurement outcome (in this example, the desirable measurement outcome is “negative”), and a second corresponding label relating to a location matches a target location (in this example, the target location is “Office A”). It is determined that only input image 506a comprises labels matching both the measurement outcome and the target location conditions, and a match with the subject in node ID A2 in the network diagram. As a result, with at least two matching corresponding labels, the node with node ID A2 is eliminated from the network diagram.

FIG. 5B shows another example process of determining whether or not to eliminate a node representing a subject in a network of subjects based on two corresponding labels matching a target location and a target time period respectively. In an embodiment, a node is to be eliminated if a first corresponding label relating to a location matches a target location (in this example, the target location is “L3” or “Level 3”), and a second corresponding label relating to a date falls within a target time period (in this example, the target time period is between 11-Jan to 31-Jan). It is determined that input images 504b and 506b comprise labels matching both the target location and the target time period conditions, and a match with the subjects in node IDs A19 and A2 in the network diagram, respectively. As a result, with at least two matching corresponding labels, the nodes with nodes ID A19 and A2 are eliminated from the network diagram.

FIG. 5C shows yet another example process of determining whether or not to eliminate a node representing a subject in a network of subjects based on at least two of three corresponding labels matching a desirable measurement outcome, a target location and a target numerical value. In an embodiment, a node is to be eliminated if at least two of the conditions met: (a) a first corresponding label relating to measurement outcome matches a desirable measurement outcome (in this example, the desirable measurement outcome is “negative”); (b) a second corresponding label relating to a location matches a target location (in this example, the target location is “L3” or “Level 3”); and (c) a third corresponding label has a numerical value smaller than or equal to a threshold number (in this example, the threshold number is 50). It is determined that only input image 504c comprise at least two corresponding labels of “L3” and “40” (smaller than the threshold value of 50) matching the target location and the target numerical value conditions, and a match with the subject in node IDs A19 of the network diagram. As a result, with at least two matching corresponding labels, the node with node ID A19 is eliminated from the network diagram.

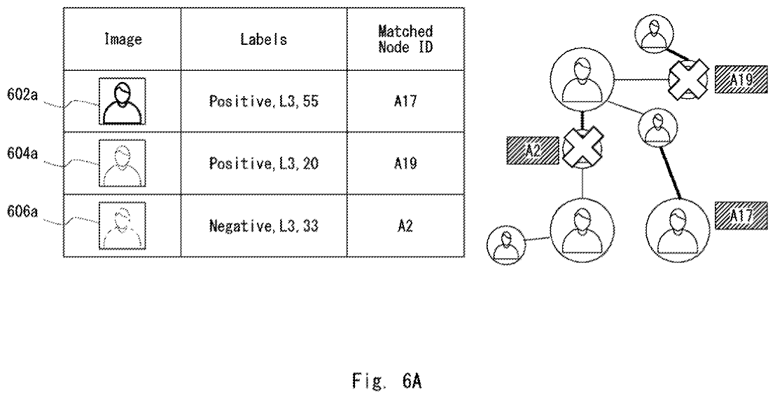

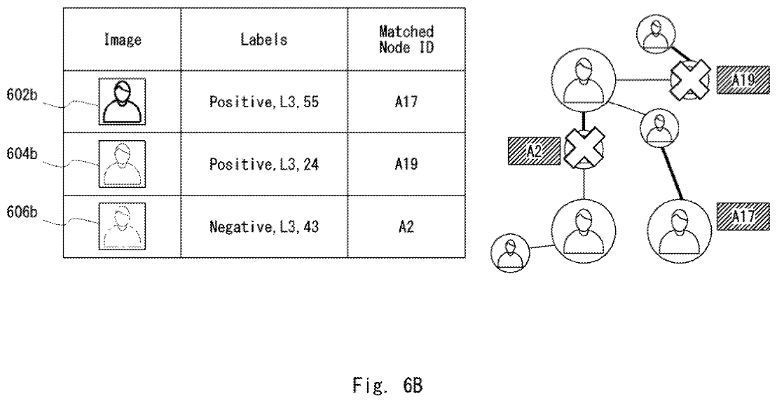

FIGS. 6A-6B show example processes of determining whether or not to eliminate a node representing a subject in a network of subjects based on one and/or two types of labels matching respective conditions.

FIG. 6A shows an example process of determining whether or not to eliminate a node representing a subject in a network of subjects based on one corresponding label matching a desirable measurement outcome or two corresponding labels matching a target location and a target numerical value respectively. In an embodiment, a node is to be eliminated if a first corresponding label relating to a measurement outcome matches a desirable measurement outcome. In this example, the desirable measurement outcome is “negative”. Alternatively, a node is also to be eliminated if a second corresponding label relating to a location matches a target location (in this example, the target location is “L3”) and a third corresponding label has a numerical value smaller than or equal to a threshold number (in this example, the threshold number is 50). It is determined that input image 606a comprises one corresponding label matching the measurement result condition, and a match with the subject in node ID A2 of the network diagram, while it is determined that the input image 604a comprises two corresponding labels of “L3” and “20” (smaller than the threshold value of 50) matching the target location and the target numerical value conditions, and a match with the subject in node IDs A19 of the network diagram. As a result, with at least one or two matching corresponding labels depending on the type of label, the nodes with nodes ID A2 and A19 are respectively eliminated from the network diagram.

FIG. 6B shows another example process of determining whether or not to eliminate a node representing a subject in a network of subjects based on one corresponding label matching a desirable measurement outcome or two corresponding labels matching a target location and a target numerical value respectively. In an embodiment, a node is to be eliminated if a first corresponding label relating to a measurement outcome matches a desirable measurement outcome. In this example, the desirable measurement outcome is not “positive”, e.g., “negative”. Alternatively, a node is also to be eliminated if a second corresponding label relating to a location matches a target location (in this example, the target location is “L3”) and a third corresponding label has a numerical value in a target range of value (in this example, the target range of value between “20” and “30”). It is determined that input image 606b comprises one corresponding label matching the measurement result condition (not “positive”), and a match with the subject in node ID A2 of the network diagram, while it is determined that the input image 604b comprises two corresponding labels of “L3” and “24” (within the target range of value) matching the target location and the target range of value conditions, and a match with the subject in node IDs A19 of the network diagram. As a result, with at least one or two matching corresponding labels depending on the type of label, the nodes with nodes ID A2 and A19 are respectively eliminated from the network diagram.

In various embodiments, subsequent to determining whether or not to eliminate a node representing a subject in the network of subjects based on the at least one corresponding label, a group score indicating an overall connection strength of a group of subjects may be calculated for every group of subjects in the network of subjects. In an embodiment, a group score is calculated based on at least one parameter relating to a group of subjects, such as a number of nodes of each group of subjects and a connection strength(s) of every two connected nodes (subjects) in each group of subjects, where the connection strength of two connected nodes may be calculated by a count of co-appearance(s) between the two subjects corresponding to the two connected nodes. As such, a high group score may indicate that there are more subjects within a group of subjects and/or the connection strengths among the subjects within a group of subjects are greater.

All groups of subjects can be ranked according to their respective group scores, and as a result, the user can easily identify that which group of subjects have greater (or weaker) connection strength among its subjects or that they are more (or less) closely related to each other, e.g., in contact with each other more (or less) often, than other group of subjects. Furthermore, the user can make quicker decision to carry out actions to the group of subjects, for example assigning more (or less) resources to and giving more (or less) priority in investigation and monitoring of the subjects in the group of subjects.

According to the present disclosure, a node representing a subject in the network of subject identified from an image input comprising a specific label may be determined not to be eliminated from the network of subject. In an embodiment, the specific label for determining a node not to be eliminated refers to the information or feature, e.g., positive measurement outcome, that is dissimilar to that of the matching label, e.g., negative measurement outcome. As such, it is then identified which group of subjects within the network of subjects comprises the subject represented by the node with the specific label, and the group score of the group of subjects comprising the subject with the specific label will be amplified. As a result, with the amplified group score of the group of subjects comprising the subject associated with a specific label, the user can easily identify those groups of subjects that have more subjects associated with the specific label, and make quicker decision to carry out actions to the group of subjects, for example, assigning more resources to and giving more priority in investigation and monitoring of the subjects in the group of subjects.

FIG. 7A shows a process of calculating a group score of each group of subjects in a network of subjects according to an embodiment. In this embodiment, based on input images 704a, 706a comprising a first corresponding label matching a target location of “L3”, it is determined that node IDs A19 and A2 is to be eliminated, and as a result of the eliminations of node IDs A19 and A2, three groups of subjects 708a, 710a, 712a comprising two, three and one subjects respectively are formed. Furthermore, it is determined that node IDs A17 identified from input image 702a with the first corresponding label relating to a location of “L5” is not to be eliminated and the second group of subjects G2 or 710a comprises the subject represented by the node IDs A17. According to this embodiment, a node determined not to be eliminated, in this case with the first corresponding label relating to the location of “L5”, will contribute “10” multiplier coefficient to group score for each connection (edge) in the group of subjects. Based on the above, a group score of each of the group of subjects 708a, 710a, 712a may be calculated using the following equation (1):

Group score=(Number of nodes)+(All updated connection strength)+(10×Number of connection) (i)

The first group of subjects 708a of the network of subjects comprises two nodes, one connection edge with co-appearance strength of 2 and no node that is identified from image input having the matching corresponding label. Thus, based on the equation (i), the group score of the first group of subjects 708a is (2)+(2) +(0), which is 4. The second group of subjects 710a of the network of subjects comprises three nodes, two connection edges with co-appearance strengths of 2 and 5 and one node ID A17 that is identified from image input 702a having the matching corresponding label “L5”. Thus, based on the equation (i), where “10” multiplier coefficients are given to every connection edge in the second group of subjects 710a, the group score of the second group of subjects 710a is (3)+(2+5) +(10×2), which is 30. The third group of subjects 712a of the network of subjects comprises 1 node, no connection edge and no node that is identified from the image input having the matching corresponding label. Thus, based on the equation (i), the group score of the third group of subjects 712a is 1.

FIG. 7B shows a process of calculating a group score of each group of subjects in a network of subject according to another embodiment. In this embodiment, based on input images 704b, 706b comprising a second corresponding label matching a target location of “L3”, it is determined that node IDs A19 and A2 is to be eliminated, and as a result of the eliminations of node IDs A19 and A2, three groups of subjects 708b, 710b, 712b comprising two, three and one subjects respectively are formed. Furthermore, it is determined that node IDs A17 identified from input image 702b with a first corresponding label relating to a measurement outcome of “positive” is not to be eliminated and the second group of subjects G2 or 710b comprises the subject represented by the node IDs A17. According to this embodiment, a node determined not to be eliminated, in this case with the first corresponding label relating to a measurement outcome of “positive”, will have each connection strength relating to the node multiplied by 10, a group score of each of the group of subjects 708b, 710b, 7b may be calculated using the following equation (ii):

Group score=(Number of nodes)+(All updated connection strength) (ii)

The first group of subjects 708b of the network of subjects comprises two nodes, one connection edge with co-appearance strength of 2 and no node that is identified from image input having the matching corresponding label. Thus, based on the equation (ii), the group score of the first group of subjects 708a is (2)+(2) +(0), which is 4. The second group of subjects 710b of the network of subjects comprises three nodes, two connection edges with co-appearance strengths of 2 and 5 and one node ID A17 that is identified from image input 702b having the matching corresponding label “positive”. Thus, based on equation (ii), where every connection strength relating to node ID A17 is multiplied by 10, the group score of the second group of subjects 710b is (3)+(2+5×10), which is 55. The third group of subjects 712b of the network of subjects comprises 1 node, no connection edge and no node that is identified from the image input having the matching corresponding label. Thus, based on the equation (ii), the group score of the third group of subjects 712b is 1.

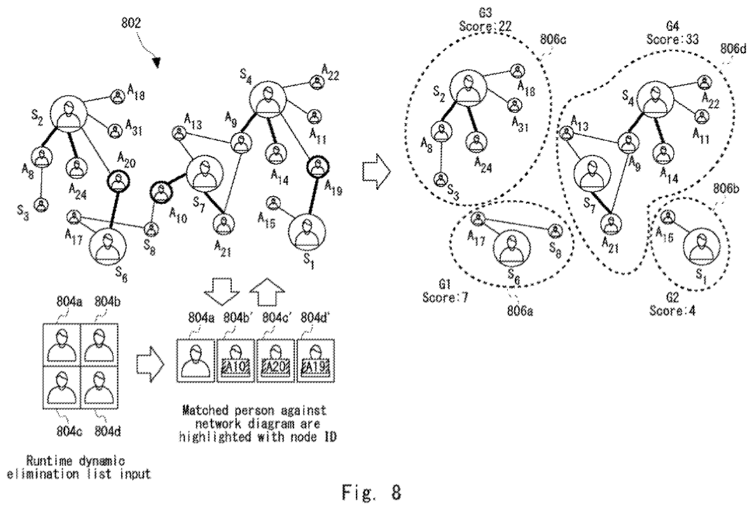

FIG. 8 shows a flow diagram illustrating a method of adaptively managing image corresponding to a network of subjects 802 according to an embodiment of the present disclosure. The network of subjects 802 may be identified and generated according to FIG. 3A and their respective counts of co-appearances based from images of subject appearances stored in an appearance database such as 307. Each node in the network of subjects represents a subject which one or more appearances are identified from the images.

In this embodiment, a thicker edge may represent greater connection strength between two nodes (subjects). A list of four input images 804a-804d, each comprising an appearance of a subject captured by one or more image capturing devices and one or more labels, may be received and used for runtime dynamic elimination of node(s) of the network of subjects 802 based on the list of input images 804a-804d. Each of the input images in the list may be matched against each subject in the network of subjects 802 by comparing the appearance of a subject in each of the input images against one or more appearances of each subject in the network of subjects. In this embodiment, the appearances in input images 804b, 804c, 804d match the subject represented in node IDs A10, A20 and A19 of the network of subjects respectively, as illustrated in 804b′, 804c′ and 804d′.

Subsequently, it is determined that the node IDs A10, A20 and A19 identified from the input images 804b-804d are to be eliminated based on the corresponding one or more labels, and as a result of elimination of nodes A10, A20 and A19 from the network of subjects, four groups of subjects 806a-806d are generated. Subsequently, a group score indicating an overall connection strength of a group of subjects may be calculated for each of the four groups of subjects 806a-806d. In an embodiment, prior to calculation of the group score, it is further determined if there is any node, identified from the input images with a specific label, not to be eliminated. In this embodiment, a group score may be calculated by summing the number of nodes and all updated co-connection strength in each group of subjects. The group scores of the first, second, third and fourth groups of subjects G1-G4 or 806a-806d respectively are calculated to be 7, 4, 22 and 33. According to the group scores, the user can easily identify fourth group of subjects G4 806d have greater connection strength among its subjects or that they more (or less) closely related to each other, and therefore the user is able to quickly carry out actions, for example assigning more (or less) resources to and given more (or less) priority in monitoring and testing the subjects, onto the fourth group of subjects 806d; whereas the user can easily identify second group of subjects G2 806b have weaker connection strength among its subjects, probably due to a small number of subjects in the group of subjects, and therefore the user is able to carry out corresponding actions, for example assigning less resources to and giving less priority in investigation and monitoring of the subjects in the group of subjects in the context of pandemic.

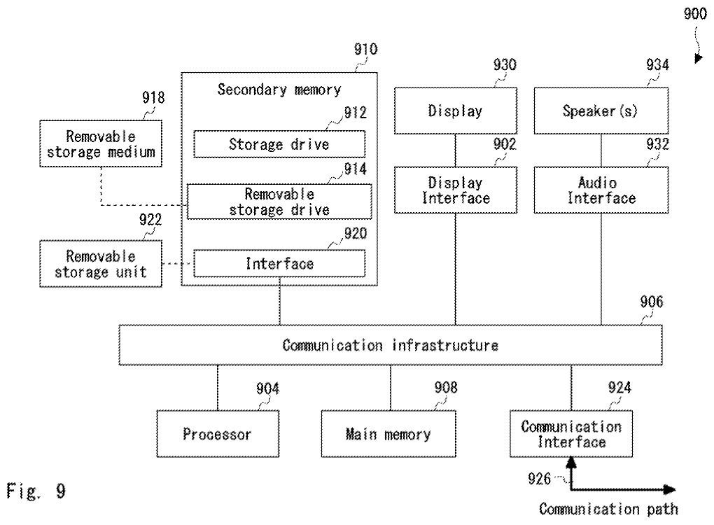

FIG. 9 depicts an exemplary computing device 900, hereinafter interchangeably referred to as a computing system 900 or as a device 900, where one or more such computing devices 900 may be used to implement the system 100 shown in FIG. 1 or the method of the earlier figures. The following description of the computing device 900 is provided by way of example only and is not intended to be limiting.

As shown in FIG. 9, the example computing device 900 includes a processor 904 for executing software routines. Although a single processor is shown for the sake of clarity, the computing device 900 may also include a multi-processor system. The processor 904 is connected to a communication infrastructure 906 for communication with other components of the computing device 900. The communication infrastructure 906 may include, for example, a communications bus, cross-bar, or network.

The computing device 900 further includes a primary memory 908, such as a random access memory (RAM), and a secondary memory 910. The secondary memory 910 may include, for example, a storage drive 912, which may be a hard disk drive, a solid state drive or a hybrid drive and/or a removable storage drive 914, which may include a magnetic tape drive, an optical disk drive, a solid state storage drive (such as a USB (Universal Serial Bus) flash drive, a flash memory device, a solid state drive or a memory card), or the like. The removable storage drive 914 reads from and/or writes to a removable storage medium 918 in a well-known manner. The removable storage medium 918 may include magnetic tape, optical disk, non-volatile memory storage medium, or the like, which is read by and written to by the removable storage drive 914. As will be appreciated by persons skilled in the relevant art(s), the removable storage medium 918 includes a computer readable storage medium having stored therein computer executable program code instructions and/or data.

In an alternative implementation, the secondary memory 910 may additionally or alternatively include other similar means for allowing computer programs or other instructions to be loaded into the computing device 900. Such means can include, for example, a removable storage unit 922 and an interface 920. Examples of the removable storage unit 922 and interface 920 include a program cartridge and cartridge interface (such as that found in video game console devices), a removable memory chip (such as an EPROM (Erasable Programmable Read Only Memory) or PROM) and associated socket, a removable solid state storage drive (such as a USB flash drive, a flash memory device, a solid state drive or a memory card), and other removable storage units 922 and interfaces 920 which allow software and data to be transferred from the removable storage unit 922 to the computing system 900.

The computing device 900 also includes at least one communication interface 924. The communication interface 924 allows software and data to be transferred between computing device 900 and external devices via a communication path 926. In various embodiments of the disclosure, the communication interface 924 permits data to be transferred between the computing device 900 and a data communication network, such as a public data or private data communication network. The communication interface 924 may be used to exchange data between different computing devices 900; such computing devices 900 form part an interconnected computer network. Examples of the communication interface 924 can include a modem, a network interface (such as an Ethernet card), a communication port (such as a serial, parallel, printer, GPIB (General Purpose Interface Bus), IEEE (Institute of Electrical and Electronics Engineers) 1394, RJ45, USB), an antenna with associated circuitry and the like. The communication interface 924 may be wired or may be wireless. Software and data transferred via the communication interface 924 are in the form of signals which can be electronic, electromagnetic, optical or other signals capable of being received by the communication interface 924. These signals are provided to the communication interface 924 via the communication path 926.

As shown in FIG. 9, the computing device 900 further includes a display interface 902 which performs operations for rendering images to an associated display 930 and an audio interface 932 for performing operations for playing audio content via associated speaker(s) 934.

As used herein, the term “computer program product” (or computer readable medium, which may be a non-transitory computer readable medium) may refer, in part, to removable storage medium 918, removable storage unit 922, a hard disk installed in storage drive 912, or a carrier wave carrying software over the communication path 926 (wireless link or cable) to the communication interface 924. Computer readable storage media (or computer readable media) refers to any non-transitory, non-volatile tangible storage medium that provides recorded instructions and/or data to the computing device 900 for execution and/or processing. Examples of such storage media include magnetic tape, CD-ROM (Compact Disc-Read Only Memory), DVD (Digital Versatile Disc), Blu-ray TM Disc ((R): Registered trademark), a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA (Personal Computer Memory Card International Association) card and the like, whether or not such devices are internal or external of the computing device 900. Examples of transitory or non-tangible computer readable transmission media that may also participate in the provision of software, application programs, instructions and/or data to the computing device 900 include radio or infra-red transmission channels as well as a network connection to another computer or networked device, and the Internet or Intranets including e-mail transmissions and information recorded on Websites and the like. Also, the computer program may be transmitted on electrical, optical, acoustical, or other form of propagated signals.

The computer programs (also called computer program code) are stored in the primary memory 908 and/or secondary memory 910. The computer programs can also be received via the communication interface 924. Such computer programs, when executed, enable the computing device 900 to perform one or more features of embodiments discussed herein. In various embodiments, the computer programs, when executed, enable the processor 904 to perform features of the above-described embodiments. Accordingly, such computer programs represent controllers of the computing system 900.

Software may be stored in a computer program product and loaded into the computing device 900 using the removable storage drive 914, the storage drive 912, or the interface 920. The computer program product may be a non-transitory computer readable medium. Alternatively, the computer program product may be downloaded to the computing system 900 over the communications path 926. The software, when executed by the processor 904, causes the computing device 900 to perform functions of embodiments described herein.

It is to be understood that the embodiment of FIG. 9 is presented merely by way of example. Therefore, in some embodiments one or more features of the computing device 900 may be omitted. Also, in some embodiments, one or more features of the computing device 900 may be combined together. Additionally, in some embodiments, one or more features of the computing device 900 may be split into one or more component parts.

(Second Example Embodiment)

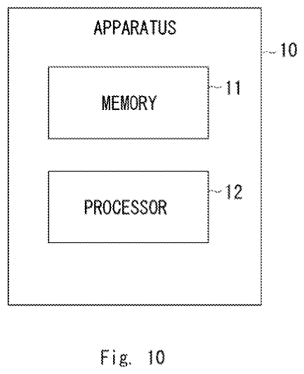

A Second example embodiment of the disclosure is explained below referring to FIG. 10. The second example embodiment shows generic concept of this disclosure; however, it does not show the limit of this disclosure.

FIG. 10 shows a block diagram of an apparatus 10. The apparatus 10 includes a memory 11 and a processor 12. The memory 11 is in communication with the processor 12, while the memory 11 stores a computer program recorded therein.

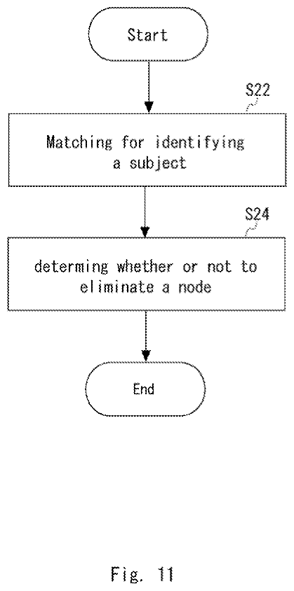

FIG. 11 shows a flowchart 20 illustrating how the apparatus 10 performs when the computer program in the memory 11 is executed by the processor 12.

In step 22, the apparatus 10 matches an input image against at least one of images corresponding to a network of subjects to identify a subject corresponding to the input image. The input image includes at least one label corresponding to the identified subject.

In step 24, the apparatus 10 determines whether or not to eliminate a node representing the subject in the network of subjects based on the at least one corresponding label.

In one embodiment, there may be a system including the apparatus 10 and at least one image capturing device, which captures the input image.

The present disclosure relates broadly, but not exclusively, to a method and a device for adaptively managing images corresponding to a network of subjects.

It will be appreciated by a person skilled in the art that numerous variations and/or modifications may be made to the present invention as shown in the specific embodiments without departing from the spirit or scope of the invention as broadly described. For example, the above description mainly presenting alerts on a visual interface, but it will be appreciated that another type of alert presentation, such as sound alert, can be used in alternate embodiments to implement the method. Some modifications, e.g., adding an access point, changing the log-in routine, etc. may be considered and incorporated. The present embodiments are, therefore, to be considered in all respects to be illustrative and not restrictive.

Part of or all the foregoing embodiments can be described as in the following appendixes, but the present disclosure is not limited thereto. (Supplementary Note 1)

A method comprising:
matching an input image against at least one of images corresponding to a network of subjects to identify a subject corresponding to the input image, the input image comprising at least one label corresponding to the identified subject; and
determining whether or not to eliminate a node representing the subject in the network of subjects based on the at least one corresponding label. (Supplementary Note 2)

The method according to Supplementary Note 1, further comprising:
when it is determined the node representing the subject in the network of subjects is to be eliminated,
generating two or more groups of subjects within the network of subjects in response to the elimination. (Supplementary Note 3)

The method according to Supplementary Note 2, wherein the node represents the subject in a group of subjects within the network of subjects, and the two or more groups of subjects are generated in the group of subjects within the network of subjects in response to the elimination. (Supplementary Note 4)

The method according to Supplementary Note 2 or 3, further comprising:
calculating a group score of each group of subjects of the two or more groups of subjects based on at least one parameter relating to the group of subjects, the group score corresponding to an overall connection strength of the group of subjects. (Supplementary Note 5)

The method according to Supplementary Note 4, wherein the at least one parameter is at least one of: a number of nodes in the group of subjects and a connection strength of every two connected nodes in the group of subjects, each node representing a subject in the group of subjects, each two connected nodes in the group of subjects representing two subjects in the group of subjects who both appear in one or more of the images corresponding to the network of subjects, and the connection strength relating to a count of co-appearance(s) of the two subjects where the two subjects both appear within a time period and/or appear respectively in two proximate time periods based on the images corresponding to the network of subjects. (Supplementary Note 6)

The method according to Supplementary Note 1, further comprising:
when it is determined the node representing the subject in the network of subjects is not to be eliminated,
identifying a group of subjects within the network of subjects, the group of subjects comprising the subject. (Supplementary Note 7)

The method according to Supplementary Note 6, further comprising: calculating a group score of the group of subjects based on a parameter relating to the group of subjects and the corresponding label of the subject, the group score corresponding to overall connection strength of the group of subjects. (Supplementary Note 8)

The method according to Supplementary Note 7, wherein the parameter is at least one of: a number of nodes in the group of subjects and a connection strength of every two connected nodes in the group of subjects, each node representing a subject in the group of subjects, each two connected nodes in the group of subjects representing two subjects in the group of subjects who both appear in one or more of the images corresponding to the network of subjects, and the connection strength relating to a total number of images of the images corresponding to the network of subjects in which the two subjects both appear, wherein a connected strength of two connected nodes in the group of subjects comprising the node representing the subject is adjusted according to the corresponding label. (Supplementary Note 9)

The method according to any one of Supplementary Notes 1 to 8, wherein the matching of the input image against the at least one of the images corresponding to the network of subjects to identify a subject corresponding to the input image comprises comparing an appearance of the subject in the input image against at least one appearance of the subject in the at least one of the images corresponding to the network of subjects. (Supplementary Note 10)

The method according to any one of Supplementary Notes 1 to 9, further comprising:
receiving an input image, the input image being at least one image captured by at least one image capturing devices. (Supplementary Note 11)

An apparatus comprising:
a memory in communication with a processor, the memory storing a computer program recorded therein, the computer program being executable by the processor to cause the apparatus at least to:
   match an input image against at least one of images corresponding to a network of subjects to identify a subject corresponding to the input image, the input image comprising a label corresponding to the identified subject; and
   determine whether or not to eliminate a node representing the subject in the network of subjects based on the corresponding label. (Supplementary Note 12)

The apparatus according to Supplementary Note 11, wherein the memory and the computer program are configured to, with the processor, cause the apparatus to further:
generate two or more groups of subjects within the network of subjects in response to the elimination, when it is determined the node representing the subject in the network of subjects is to be eliminated. (Supplementary Note 13)

The apparatus according to Supplementary Note 12, wherein the node represents the subject in a group of subjects within the network of subjects, and the two or more groups of subjects are generated in the group of subjects within the network of subjects in response to the elimination. (Supplementary Note 14)

The apparatus according to Supplementary Note 12 or 13, wherein the memory and the computer program are configured to, with the processor, cause the apparatus to further:
calculate a group score of each group of subjects of the two or more groups of subjects based on at least one parameter relating to the group of subjects, the group score corresponding to an overall connection strength of the group of subjects. (Supplementary Note 15)

The apparatus according to Supplementary Note 14, wherein the at least one parameter is at least one of: a number of nodes in the group of subjects and a connection strength of every two connected nodes in the group of subjects, each node representing a subject in the group of subjects, each two connected nodes in the group of subjects representing two subjects in the group of subjects who both appear in one or more of the images corresponding to the network of subjects, and the connection strength relating to a count of co-appearance(s) of the two subjects where the two subjects both appear within a time period and/or appear respectively in two proximate time periods based on the images corresponding to the network of subjects. (Supplementary Note 16)

The apparatus according to Supplementary Note 11, wherein the memory and the computer program are configured to, with the processor, cause the apparatus to further:
identify a group of subjects within the network of subjects, the group of subjects comprising the subject, when it is determined the node representing the subject in the network of subjects is not to be eliminated. (Supplementary Note 17)

The apparatus according to Supplementary Note 16, wherein the memory and the computer program are configured to, with the processor, cause the apparatus to further:
calculate a group score of the group of subjects based on a parameter relating to the group of subjects and the corresponding label of the subject, the group score corresponding to overall connection strength of the group of subjects. (Supplementary Note 18)

The apparatus according to Supplementary Note 17, wherein the parameter is at least one of: a number of nodes in the group of subjects and a connection strength of every two connected nodes in the group of subjects, each node representing a subject in the group of subjects, each two connected nodes in the group of subjects representing two subjects in the group of subjects who both appear in one or more of the images corresponding to the network of subjects, and the connection strength relating to a total number of images of the images corresponding to the network of subjects in which the two subjects both appear, wherein a connected strength of two connected nodes in the group of subjects comprising the node representing the subject is adjusted according to the corresponding label. (Supplementary Note 19)

The apparatus according to any one of Supplementary Notes 11 to 18, wherein the memory and the computer program are configured to, with the processor, cause the apparatus to further:
compare an appearance of the subject in the input image against at least one appearance of the subject in the at least one of the images corresponding to the network of subjects. (Supplementary Note 20)

The apparatus according to any one of Supplementary Notes 11 to 19, wherein the memory and the computer program are configured to, with the processor, cause the apparatus to further:
receive an input image, the input image being at least one image captured by at least one image capturing devices. (Supplementary Note 21)

A system comprising:
the apparatus as claimed in any one of Supplementary Notes 11 to 20 and at least one image capturing device. (Supplementary Note 22)

A non-transitory computer readable medium storing a program for causing a computer to execute:
matching an input image against at least one of images corresponding to a network of subjects to identify a subject corresponding to the input image, the input image comprising at least one label corresponding to the identified subject; and
determining whether or not to eliminate a node representing the subject in the network of subjects based on the at least one corresponding label.

This application is based upon and claims the benefit of priority from Singapore patent application No. 10202006872T, filed on Jul. 17, 2020, the disclosure of which is incorporated herein in its entirety by reference.

Reference Signs List
10 apparatus
11 memory
12 processor
100 system
102 requestor device
108 contact tracing server
109 database
116, 120-122, 144, 146 connection
140 remote assistance server
142 sensor
150 remote assistance host
900 computing device
902 display interface
904 processor
906 communication infrastructure
908 main memory
910 secondary memory
912 storage drive
914 removable storage drive
918 removable storage medium
920 interface
922 removable storage unit
924 communication interface
926 communication path
930 display
932 audio interface
934 speaker(s)

What is claimed is:

1. A method performed by a computer comprising:
matching an input image against at least one of images corresponding to a network of subjects to identify a subject corresponding to the input image, the input image comprising at least one label corresponding to the identified subject; and
determining whether or not to eliminate a node representing the subject in the network of subjects based on the at least one corresponding label.

2. The method according to claim 1, further comprising:
when it is determined the node representing the subject in the network of subjects is to be eliminated,
generating two or more groups of subjects within the network of subjects in response to the elimination.

3. The method according to claim 2, wherein the node represents the subject in a group of subjects within the network of subjects, and the two or more groups of subjects are generated in the group of subjects within the network of subjects in response to the elimination.

4. The method according to claim 2, further comprising:
calculating a group score of each group of subjects of the two or more groups of subjects based on at least one parameter relating to the group of subjects, the group score corresponding to an overall connection strength of the group of subjects.

5. The method according to claim 4, wherein the at least one parameter is at least one of: a number of nodes in the group of subjects and a connection strength of every two connected nodes in the group of subjects, each node representing a subject in the group of subjects, each two connected nodes in the group of subjects representing two subjects in the group of subjects who both appear in one or more of the images corresponding to the network of subjects, and the connection strength relating to a count of co-appearance(s) of the two subjects where the two subjects both appear within a time period and/or appear respectively in two proximate time periods based on the images corresponding to the network of subjects.

6. The method according to claim 1, further comprising:
when it is determined the node representing the subject in the network of subjects is not to be eliminated,
identifying a group of subjects within the network of subjects, the group of subjects comprising the subject.

7. The method according to claim 6, further comprising:
calculating a group score of the group of subjects based on a parameter relating to the group of subjects and the corresponding label of the subject, the group score corresponding to overall connection strength of the group of subjects.

8. The method according to claim 7, wherein the parameter is at least one of: a number of nodes in the group of subjects and a connection strength of every two connected nodes in the group of subjects, each node representing a subject in the group of subjects, each two connected nodes in the group of subjects representing two subjects in the group of subjects who both appear in one or more of the images corresponding to the network of subjects, and the connection strength relating to a total number of images of the images corresponding to the network of subjects in which the two subjects both appear, wherein a connected strength of two connected nodes in the group of subjects comprising the node representing the subject is adjusted according to the corresponding label.

9. The method according to claim 1, wherein the matching of the input image against the at least one of the images corresponding to the network of subjects to identify a subject corresponding to the input image comprises comparing an appearance of the subject in the input image against at least one appearance of the subject in the at least one of the images corresponding to the network of subjects.

10. The method according to claim 1, further comprising:
receiving an input image, the input image being at least one image captured by at least one image capturing devices.

11. An apparatus comprising:
at least one memory configured to store instructions; and
at least one processor configured to execute the instructions to:
match an input image against at least one of images corresponding to a network of subjects to identify a subject corresponding to the input image, the input image comprising a label corresponding to the identified subject; and
determine whether or not to eliminate a node representing the subject in the network of subjects based on the corresponding label.

12. The apparatus according to claim 11, wherein the at least one processor is further configured to:
generate two or more groups of subjects within the network of subjects in response to the elimination, when it is determined the node representing the subject in the network of subjects is to be eliminated.

13. The apparatus according to claim 12, wherein the node represents the subject in a group of subjects within the network of subjects, the two or more groups of subjects are generated in the group of subjects within the network of subjects in response to the elimination.

14. The apparatus according to claim 13, wherein the at least one processor is further configured to
calculate a group score of each group of subjects of the two or more groups of subjects based on at least one parameter relating to the group of subjects, the group score corresponding to an overall connection strength of the group of subjects.

15. The apparatus according to claim 14, wherein the at least one parameter is at least one of: a number of nodes in the group of subjects and a connection strength of every two connected nodes in the group of subjects, each node representing a subject in the group of subjects, each two connected nodes in the group of subjects representing two subjects in the group of subjects who both appear in one or more of the images corresponding to the network of subjects, and the connection strength relating to a count of co-appearance(s) of the two subjects where the two subjects both appear within a time period and/or appear respectively in two proximate time periods based on the images corresponding to the network of subjects.

16. The apparatus according to claim 11, wherein the at least one processor is further configured to:
identify a group of subjects within the network of subjects, the group of subjects comprising the subject, when it is determined the node representing the subject in the network of subjects is not to be eliminated.

17. The apparatus according to claim 16, wherein the at least one processor is further configured to:
calculate a group score of the group of subjects based on a parameter relating to the group of subjects and the corresponding label of the subject, the group score corresponding to overall connection strength of the group of subjects.

18. The apparatus according to claim 17, wherein the parameter is at least one of: a number of nodes in the group of subjects and a connection strength of every two connected nodes in the group of subjects, each node representing a subject in the group of subjects, each two connected nodes in the group of subjects representing two subjects in the group of subjects who both appear in one or more of the images corresponding to the network of subjects, and the connection strength relating to a total number of images of the images corresponding to the network of subjects in which the two subjects both appear, wherein a connected strength of two connected nodes in the group of subjects comprising the node representing the subject is adjusted according to the corresponding label.

19. The apparatus according to claim 11, wherein the at least one processor is further configured to:
compare an appearance of the subject in the input image against at least one appearance of the subject in the at least one of the images corresponding to the network of subjects.

20-21. (canceled)

22. A non-transitory computer readable medium storing a program for causing a computer to execute:
matching an input image against at least one of images corresponding to a network of subjects to identify a subject corresponding to the input image, the input image comprising at least one label corresponding to the identified subject; and
determining whether or not to eliminate a node representing the subject in the network of subjects based on the at least one corresponding label.
